(19) United States
(12) Patent Application Publication
(10) Pub. No.: US 2005/0287255 A1
(43) Pub. Date: Dec. 29, 2005

(54) Method for preventing the formation of spots at the surface of mushrooms and mushrooms thereby obtained

(75) Inventor: Servatius Hubertus Wilhelmus Notermans, Bilthoven (NL)

Correspondence Address: SWANSON & BRATSCHUN L.L.C., 1745 SHEA CENTER DRIVE, SUITE 330, HIGHLANDS RANCH, CO, 80129, US

(73) Assignee: Nederlandse Organisatie voor toegepastnatuurwetenschappelijk Onderzoek TNO, VK Delft (NL)

(21) Appl. No.: 10/527,558

(22) PCT Filed: Sep. 12, 2003
(86) PCT No.: PCT/NL03/00633

§ 371 Date: Mar. 10, 2005

(30) Foreign Application Priority Data
Sep. 13, 2002 (NL) 1021456

(51) Int. Cl. A23L 3/00

(52) U.S. Cl. 426/248

(57) ABSTRACT

The invention relates to a method for preventing at least the formation of spots at the surfaces of edible mushrooms such as ordinary button mushrooms. Further, the invention relates to mushrooms with a longer time of sale. By means of the invention, it has appeared possible to prolong the period between harvesting and the formation of a substantial amount of brown spots at the surface of a number of mushrooms of good quality by more than a week with respect to unthreaded mushrooms. The mushrooms are exposed to UV-light.

The invention relates to a method for preventing at least the formation of spots at the surface of edible, mushrooms such as ordinary button mushrooms. Further, the invention relates to mushrooms with a longer time of sale.

The longest storage life and hence the sell-by date of mushrooms and in particular of button mushrooms such as Agaricus bisporus is also determined by the rate at which, after harvesting, (brown) spots occur on the surface of button mushrooms.

Browning of mushrooms and in particular button mushrooms after harvesting is a known phenomenon, which reduces the commercial value of these products to a large extent. Although much research has been carried out into this browning, the exact mechanism is still not known. As a rule, the browning occurs at locations where the mushrooms are contacted during harvesting or during processing. According to one theory, bacterial growth at the location of the bruising or damage could play a part. However, more often, it is assumed that the browning is caused by polyphenol oxidases (PPOs) which, while utilizing oxygen, convert phenols into quinones. In the non-damaged mushroom, and in particular the button mushroom, PPs and phenols are separated from each other by compartmenting, so that no browning occurs. Such a discoloration reduces, for instance, the consumer's visual appreciation of the button mushrooms.

PPO is, in fact, a collective term for different types of enzymes. The most important ones among them are laccases, tyrosinases and catechol oxidases. In addition, peroxidases are mentioned as enzymes possibly involved in browning. It is known that in Agaricus, tyrosinases are the most important enzymes in relation to browning. The tyrosinase activity, in turn, consists of two reactions: cresolase activity, wherein a phenol is converted into a diphenol, and a catecholase activity, wherein a diphenol is further oxidized into an orthoquinone. Tyrosinase has a molecular weight of 128 kDA, is a tetramer and contains a copper atom in the active center. The pH optimum of this enzyme is between 6 and 7.

Starting from enzymatic browning, this could be inhibited in different manners. The quinones formed can be reduced again with a reducing agent, so that in fact, decolorization occurs. In addition, the enzyme tyrosinases can be inhibited. This can be effected by a chelator, binding the copper atom from the active center of tyrosinase, or by an inhibitor occupying the active center. A different approach is to change the circumstances such that the enzyme is no longer catalytically active or only to a reduced extent.

More in detail, reducing agents can, in turn, reduce phenols oxidized through tyrosinase and thus undo the browning action. However, a drawback is that the action is temporary because the agents lose their effect. Another drawback is that the action is not selective, so that off-odors and off-flavors may occur.

The best reducing agent appears to be sulfite. However, the use thereof in foodstuffs is being prohibited more and more. An alternative is ascorbate which has as a drawback that it is oxidized relatively rapidly and, consequently, is active for only a limited period of time. Glutathione has a better action than ascorbate, but is not usable in view of the price. A different alternative is cysteine, but the concentration required for inhibiting browning adversely affects the flavor.

It appears therefore that ascorbate (vitamin C) is the best option among the reducing agents.

Another mechanism utilizes the pH optimum of tyrosinase which is between pH 6 and 7. At a higher pH, the activity reduces only slowly, while at a lower pH, the activity rapidly decreases. Below pH 4, the enzyme is (virtually) inactive but not yet irreversibly inactivated. To that end, the pH should be lowered below 3.5. The natural pH of mushrooms is 6.3, so that a considerable acidification is required.

From U.S. Pat. No. 4,066,795 it is known that the shelf life of mushrooms can be increased by a chemical treatment with chlorine, hypoclorite and with a sulfur dioxide containing solution which effects the whitening of the mushrooms. By means of such a bleaching method, mushrooms supposedly stay white for 7-10 days at a storage temperature of 0° C.

Chinese patent 1139533 describes a complicated method wherein mushrooms are enzymatically treated and dried for 10 to 30%, whereupon they are packaged under aseptic conditions. According to the abstract, the color of the mushroom is maintained for ten days at 5 to 12° C.

There are various drawbacks attached to the chemical treatment of mushrooms. Many consumers prefer foodstuffs in which the least possible chemicals are used from a point of view of, for instance, the environment or health. In addition, wet chemical treatment generally requires an additional drying step of the mushrooms. This is time and energy consuming.

It is an object of the present invention to provide for an alternative method for preventing, at least reducing, the formation of spots, or browning, at the surface of mushrooms, in particular of ordinary button mushrooms and in particular of Agaricus bisporus.

It has been found now that formation of spots at the surface of mushrooms can be prevented, or reduced by treating the mushrooms with a particular type of light.

Therefore, the invention relates to a method for preventing the formation of spots at the surface of edible mushrooms, wherein the mushrooms are exposed to UV-light.

The mushrooms can be treated with UV-light before and/or after harvesting.

If the mushrooms are treated with UV-light after harvesting, this is preferably done within one day, most preferably within 1-6 hours after harvesting.

Very good results are obtained with a method wherein the mushrooms are treated with UV-light at least before harvesting. Preferably, this is done at least shortly before harvesting, such as within 0-12 hours before harvesting, more preferably within six hours before harvesting, most preferably within 1 hour before harvesting until immediately before harvesting.

It has been found that by effecting a UV-treatment already prior to harvesting, formation of spots resulting from mechanical damage to the surface during picking is prevented or at least reduced.

Therefore, the invention is highly suitable to be used on mushrooms which are mechanically picked.

Preferably, prior to the UV-treatment, the surface undergoes no treatment with chemical agents, such as a treatment with a preservative or coating.

It has been found that by irradiating the mushrooms with UV-light, the formation of spots can be effectively eliminated. It has, for instance, appeared possible to prolong the period between harvesting and the formation of a substantial amount of brown spots at the surface of a number of mushrooms of good quality by more than a week in relation to untreated mushrooms. Thus, it has proven possible to obtain mushrooms with a shelf life, at 10° C., of more than twelve days or even at least sixteen days. An important further advantage is that no chemicals improving the shelf life need to be used (preservatives).

It is surprising that UV-light has such an effect on mushrooms. It is known, for instance, to use UV-light for sterilizing particular types of vegetables and fruit. However, as a drawback of such a bactericidal treatment, in U.S. Pat. No. 5,364,645, browning is mentioned with doses of less than 300 mJ/cm². The use of UV-light on mushrooms, for that matter, is not described therein.

The use of high doses of UV-light (0.295-1.471 J/cm²) for reducing the amount of microbes on mushrooms has been described by Hui-Ying Tai et al. in Food Science (February 1998), 25(1):94-103. However, as an undesired side-effect of the described treatment, browning of the button mushrooms and the occurrence of color differences (ΔE)—i.e. formation of spots—is mentioned.

In Food Science 1998, 25(4), 497-504, Pei-Ru Chen and Jeng-Leun Mau describe the effect of a dose of UV-light of comparable intensity to the one in the publication mentioned hereinabove (0.295-1:471 J/cm²) on the formation of volatile compounds (in particular flavorings) in button mushrooms. They further mention that the UV-radiation leads to discoloration which may influence the acceptation of fresh food products on the market-place.

In J. Agric. Food Chem. 1998, 46, 5269-5272, Jeng-Leun Mau et al. also describe a treatment of button mushrooms with 0.295-1.471 J/cm², now for the increase of the vitamin D2 content. Here, also, the browning is mentioned as an adverse effect.

Further, it is known that button mushrooms exhibit a reduced growth in the proximity of insecticidal UV-lamps.

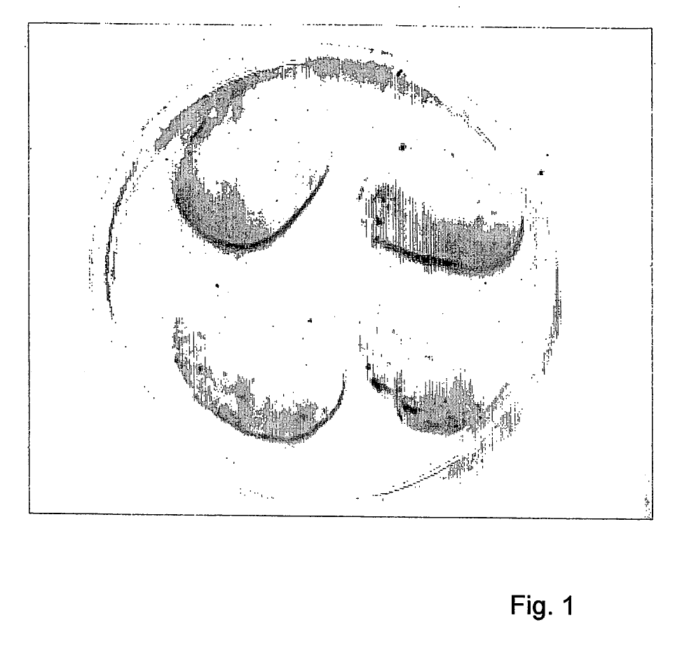

FIG. 1 shows a picture of button mushrooms immediately after harvesting, without UV-treatment (comparison).

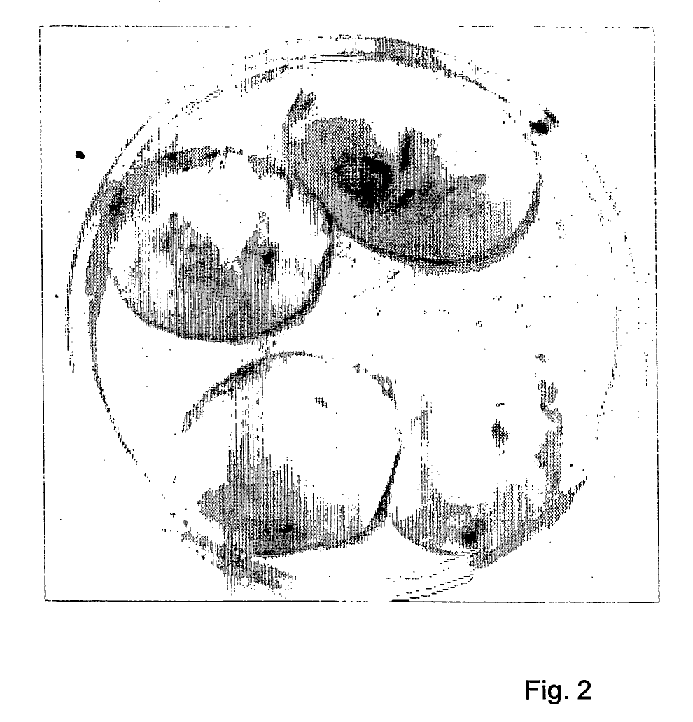

FIG. 2 shows a picture of button mushrooms which have been stored for five days at 4° C. without UV-light treatment (comparison).

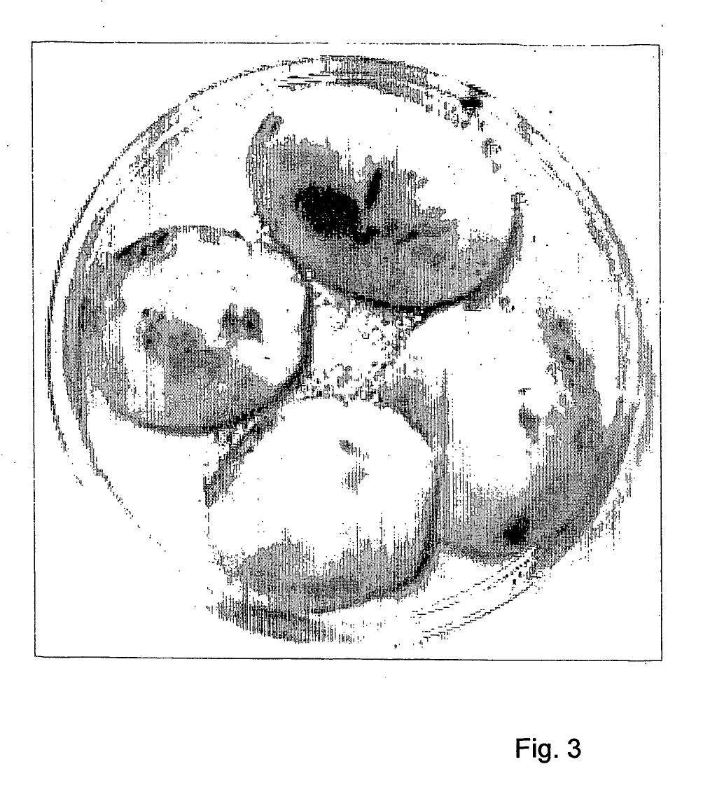

FIG. 3 shows a picture of button mushrooms which have been stored for thirteen days at 4° C. without UV-light treatment (comparison).

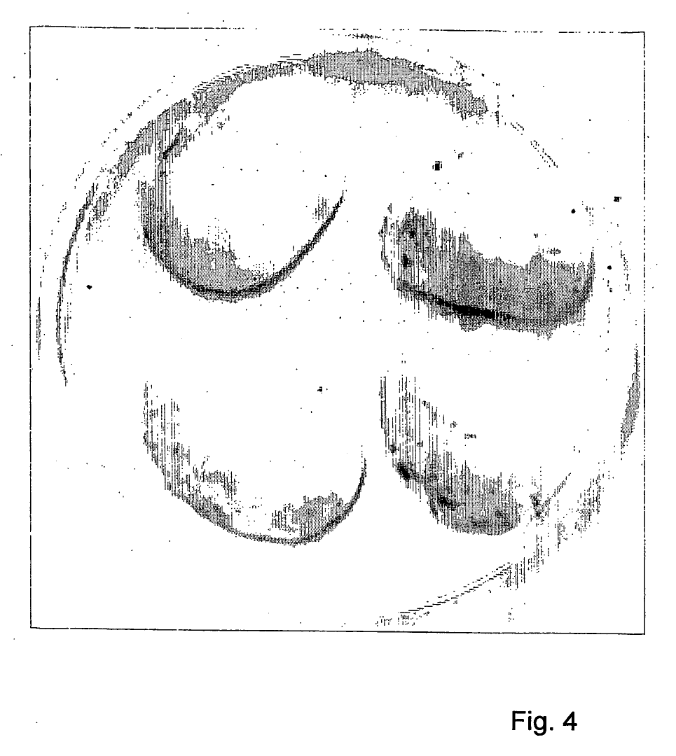

FIG. 4 shows a picture of button mushrooms immediately after having been exposed (shortly after harvesting) to UV-light for ten seconds.

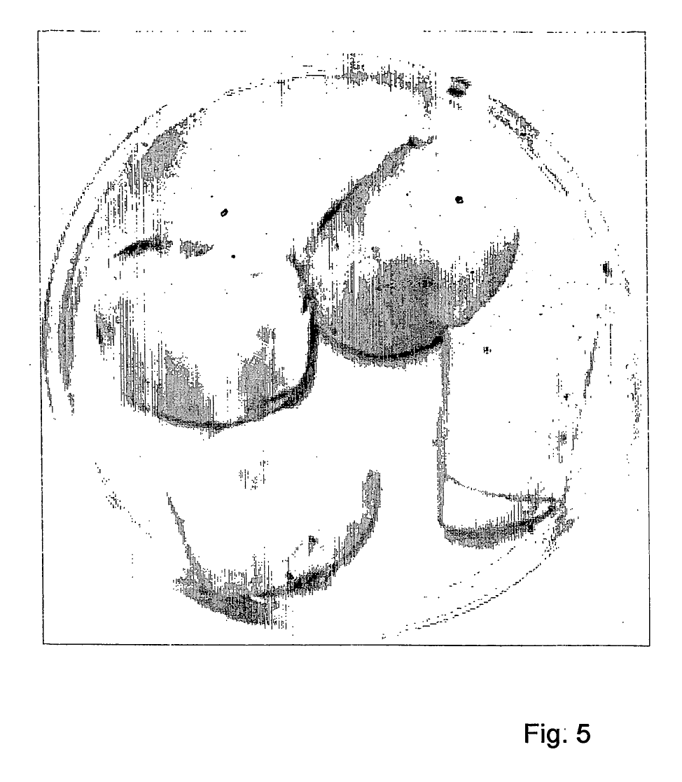

FIG. 5 shows a picture of button mushrooms which have been exposed to UV-light (shortly after harvesting) for ten seconds, after storage of 5 days at 4° C.

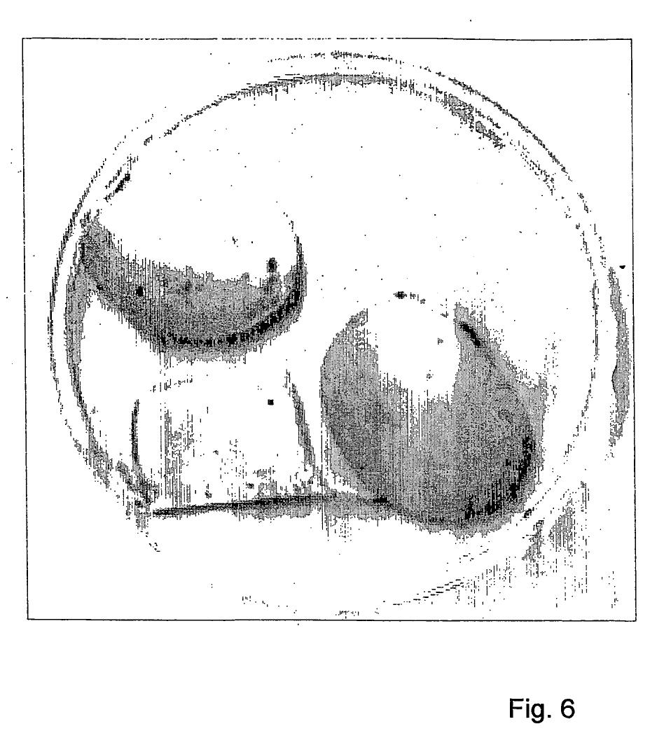

FIG. 6 shows a picture of button mushrooms which have been exposed to UV-light (shortly after harvesting) for ten seconds, after storage for 13 days at 4° C.

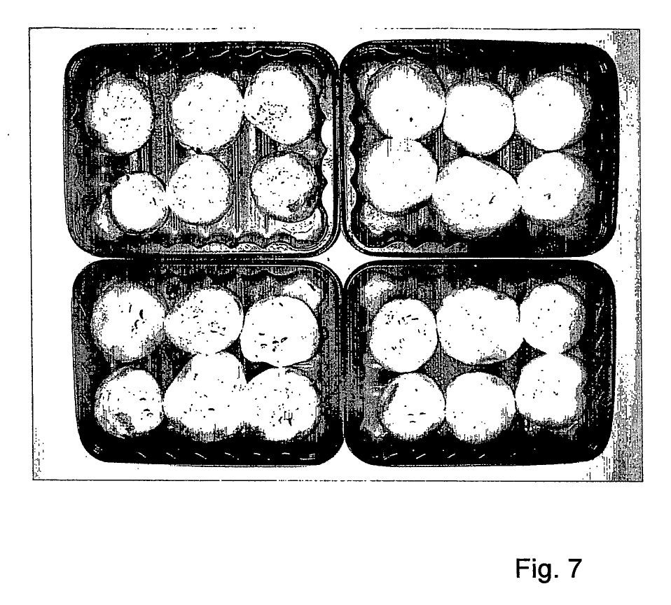

FIG. 7 shows a picture with button mushrooms which have been stored for 20 days at 7° C. The button mushrooms on the left hand side have not been treated with W-light, the mushrooms on the right hand side have been treated with UV-light before harvesting.

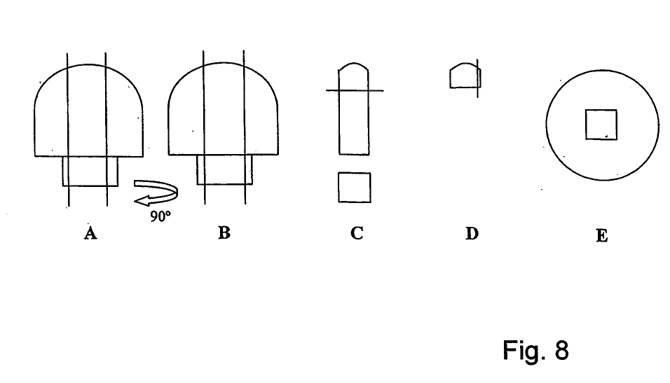

FIG. 8 schematically shows how mushrooms were cut in an experiment in which the morphology of the surface of the mushroom according to the invention was determined.

The method according to the invention can, in principle, be used with any type of mushroom in which discoloration as a result of the formation of spots plays a part. In particular, the invention relates to the treatment of white to lightly colored mushrooms, with which the formation of brown spots is delayed or prevented. Very good results are achieved in the treatment of button mushrooms, in particular of Agaricus bisporus.

In this description and claims, UV-light is understood to mean light with a wavelength in the range of 190-400 nm. The wavelength spectrum of the UV-light is not particularly critical for obtaining the technical effect found. It is not necessary that the mushroom is exclusively exposed to UV-light, for instance, visible light or infrared light may be also present in the light to which the mushroom is exposed.

In principle, any artificial light source can be used which generates a substantial amount of UV-light. Particularly suitable is a light source emitting a substantial amount of UV-light with a wavelength from the UV-C range, more specifically the wavelength range of 200-280 nm. Preferably at least 50% of the intensity of the emitted UV-light is formed by UV-C light.

Examples of suitable light sources are mercury lamps, xenon lamps, and LEDs. Very good results are obtained with a lamp emitting substantially UV-light with one or more wavelengths in the range of 250-260 nm, for instance a mercury lamp (which, as a rule, has a sharp peak in the intensity at 253.7 nm) such as a low pressure mercury vapor discharge tube.

The light source used can be a continuous or a pulsed light source. Pulsed light sources emit light during a particular period of time, typically of, at most, 0.1 sec., alternated with a lightless period. For practical reasons, a continuous light source is preferred because, with it, generally, the administered amount of light can be dosed in an easier manner. It is emphasized that, naturally, it is also possible to treat the button mushrooms several times, for instance during at least one second, with a: continuous light source. The required time of exposure can easily be determined by the skilled person on the basis of the emitted light intensity of the light source used and the total exposure energy to which he wishes to expose the mushrooms. The Uv-light intensity generated by the light source per time unit is not particularly critical. For practical reasons, it is preferred that the intensity is such that the surface of the mushrooms is exposed less than 10 minutes for effecting a desired total amount of supplied exposure energy. Good results have been obtained, for instance, with a continuous light source with a total exposure time in the range of 5 seconds to 5 minutes, in particular in the range of 10 seconds to 3 minutes.

Delaying the moment the formation of spots or browning at the surface of a mushroom becomes noticeable can already be effected with a relatively low dose of UV-light, for instance a dose of at least 0.001 J/cm² exposure energy, based on the amount of UV-light.

The upper limit is, in principle, not particularly critical, although at a high dose, a uniform browning can occur, and, at a high dose, it has been found that a button mushroom becomes tough more rapidly (See Table 1, Example 1). A reason for using a relatively high dose, for instance up to 0.5 J/cm² or more, can be that in addition to suppression of the formation of brown spots, to an increasing extent, microorganisms are killed on the surface of the mushroom. Internal research, for that matter, has shown that the effect of UV-light on the killing of microorganisms on the surface of mushrooms, in particular button mushrooms, is much smaller than with vegetables and fruit. It is assumed that due to the rugged surface of mushrooms, a relatively large part of the microorganisms present is insufficiently exposed to the UV-light.

Preferably, the total exposure energy based on the amount of UV-light is 0.01-0.25 J/cm², because with this, formation of spots can be prevented well while also, (homogenous) browning can be hardly if at all observed and/or the button mushrooms do not become tough or at least less tough than when exposed to higher doses.

Very good results are obtained with a total exposure energy in the range of 0.03-0.15 J/cm², more m particular with a total exposure energy of 0.05-0.1 J/cm². Such an amount has proven eminently effective for preventing the formation of spots without changes occurring on the surface which can be observed with the naked eye.

The invention further relates to a mushroom and, in particular a button mushroom obtainable by means of a method according to the invention. Such a mushroom has a longer shelf life than a mushroom which has not been treated with UV-light but, for the rest, has been treated in the same manner. Further, this mushroom can be characterized on the basis of microscopy and/or with the aid of a method of penetration. As is, for instance, shown in the Examples, such a mushroom has top layer with, at least substantially, dead cells. In particular, such a top layer has a thickness of, on average, approximately 75-175 μm. When compared to a mushroom treated with UV in the conventional manner, a mushroom according to the invention is lightly colored. A mushroom according to the invention is characterized in particular in that hardly or no spot formation occurs, even after 10-20 days of storage at 4, 7 or 10° C.

Further, the invention relates to a mushroom with a shelf life, at 10° C., in harvested condition, of more than 12 days, preferably at least 16 days, more preferably 18-30 days.

Preferably, a mushroom according to the invention is, in fact, free of added chemicals, in particular of added preservatives.

The invention further relates to the use of W-light, preferably UV-light as described hereinabove, for prolonging the shelf life of mushrooms, in particular button mushrooms. In particular, the invention further relates to the use of UV-light for preventing discoloration at the surface of a mushroom, in particular to the delay or prevention of the formation of brown spots at the surface of a mushroom.

The invention is presently illustrated on the basis of the following examples, which, for that matter, are not limitative to the invention.

### Example 1

Button mushrooms of good quality were exposed to UV-light from Philips model TUV PL-S 11 Watt. This low pressure mercury vapor discharge tube emits light with, mostly, a wavelength of 253.7 nm (an estimated 95% of the total intensity). The set-up was such that an exposure time of 10 seconds resulted in a total UV-light energy of 0.03 J/cm². Different button mushrooms were exposed to exposure times varying from 0-160 sec. Shortly after irradiation, the button mushrooms were examined. The results of the examination are in Table 1.

TABLE 1
Effect of the treatment with continuous UV-light

| Exposure | Exposure | |
|---|---|---|
| time | energy | |
| (sec) | (J/cm²) | Observation |
| 0 | 0 | Blank |
| 10 | 0.03 | no noticeable change with respect to blank |
| 40 | 0.12 | no noticeable change with respect to blank |
| 160 | 0.48 | After treatment, button mushrooms have a |
| | | somewhat light brown color; after some days, |
| | | the surface is slightly tougher |

A number of button mushrooms were stored for a number of days at 4° C. or 10° C. in a dark space.

During storage of the untreated button mushrooms at 4° C., the number of brown spots at the surface gradually increased (see also FIGS. 1, 2 and 3). Also, over the entire surface, the color of the button mushrooms became somewhat darker.

On the treated button mushrooms, hardly any brown spots developed (see FIGS. 4, 5 and 6 for the button mushrooms which are exposed for 10 seconds). The color of the button mushrooms hardly changed either, if at all, during storage. After 16 days, the treated button mushrooms were clearly consumable, in contrast with the untreated button mushrooms.

During storage at 10° C., the number of spots on the untreated button mushrooms grew rapidly. After 8-11 days, the button mushrooms were no longer consumable.

On the treated button mushrooms, hardly any spots developed for at least 13 days. The color hardly changed either during storage. Also after 16 days, the button mushrooms were still consumable.

### Example 2

The experiments of Example 1 were repeated with comparable button mushrooms. Instead of a continuous light source, a pulsed light source was used.

The pulsed light source was a xenon gas filled high voltage lamp of quartz glass. The discharge voltage was 1500 V with a pulse length of 0.2 msec. The emitted light had a spectrum of 190-1100 nm and an estimated total light energy of 2.0 J/cm². The portion of UV-light was estimated at 5%, so that the UV-light energy the surface of the mushrooms was exposed to is an estimated 0.1 J/cm². Immediately after the treatment, no changes were observed with respect to the blank. Both at a storage temperature of 4° C. and of 10° C., the button mushrooms were clearly consumable on day 13. After 16 days too, hardly any formation of brown spots had occurred.

### Example 3

Shortly before picking, trays with button mushrooms were placed in an NPT-tunnel and exposed to an amount of UV-light of 0.09 J/cm², (3.1 mW/cm² for 30 seconds). Trays with untreated button mushrooms served as control.

The mushrooms were picked in a standard manner or entirely without damage (accurately picked) and placed, after the stipes had been cut off, in a shallow tray. Thereupon, the trays were covered and subsequently stored at a temperature of 7° C. and a relative humidity of 93%. At regular intervals, the button mushrooms were visually examined and photos were taken.

Effect of Damage

Of a number of trays with exposed button mushrooms, 10 minutes after exposure, the mushrooms were manually bruised by pressing on them with a small stick. This was also done with unexposed button mushrooms. The trays were covered and subsequently stored for 20 days at a temperature of 7° C. and a relative humidity of 93%. At regular intervals, the button mushrooms were visually examined.

Results:

The exposure with 0.09 J/cm² yielded hardly any discoloration; and the thus treated button mushrooms had a very good shelf life.

After 10 days of storage, there were next to no visual differences between the bruised, exposed button mushrooms and the non-bruised, exposed button mushrooms. However, with the unexposed button mushrooms, an unacceptable formation of spots had occurred.

After 20 days of storage at a temperature of 7° C., the (standard picked) button mushrooms treated with 0.09 J/cm², in contrast with the untreated button mushrooms, looked acceptable (see FIG. 7; on the right hand side treated; on the left hand side: not treated with UV).

This experiment indicates that spot formation as a result of mechanical damage (which simulates damage that can occur in practice, when picking) can be prevented by treating mushrooms, prior to harvesting, with UV-light.

### Example 4

Morphological and histological analysis of the top layer of button mushrooms after UV-irradiation.

Material and Methods.

After UV-treatment, the button mushrooms were analyzed through CLSM (confocal LASER scanning microscopy) on a Biorad MRC 1024ES. Use was made of the Krypton/Argon laser, while excitation was carried out at 488 nm and 568 nm. As emission filter, use was made of the 605 nm on PMT1 (photo multiplier 1) and the 533 nm on the PMT 2.

With a clean, sharp scalpel, the sides were cut from the furnished button mushrooms (see FIG. 8 A and B for cutting lines). Thereupon, the top was cut from the obtained small rod (FIG. 8C). At the upper side of this top, the outside of the button mushroom was still present and intact. Transverse to this top layer, thin slices were made (FIG. 8D), which were colored.

FIG. 8A is a side view of a button mushroom with cutting lines on the left and right hand sides. B: FIG. 8A, after cutting, rotated over 90°, and cut again on the left and right hand sides. C: Side view of the “small rod” of the core of the button mushroom obtained from A and B with the top at the upper side. This top is subsequently cut off. D: From this top, the eventual cross sections were taken. These were thin slices of approximately 1-2 mm thickness. E: Top plan view of an intact mushroom with, indicated in the square in the center, the location where the top layer has been analyzed.

For coloring live cells, use was made of FDA (fluorescein diacetate). In living cells, this fluorochrome is cleaved by esterases and then starts to fluoresce. For coloring dead cells; use was made of PI (prodium iodide). This is a fluorochrome that cannot cross the membrane of living cells. However, with dead cells, whose cell membrane integrity is lost, PI can enter the cell to color DNA there. Hence, the fluorochrome cannot enter living cells.

FDA is excited at 488 nm, and emission of light takes place at 522 nm (in the images, this can be seen as green). Propodium iodide is excited at 568 nm and emission takes place at 605 nm (visible as red).

The cut slices of button mushroom were colored for 5 minutes with 4 μg/ml prodidium iodide and 0.5 μg/ml FDA in demineralized water. Thereafter, the slices were washed two times three minutes in demineralized water and laid on an object glass. The slices were enclosed in gelvatol (aqueous gel) with DABCO (anti-quenching) and covered with a cover glass.

### RESULTS AND DISCUSSION

Twice, photos were taken of a batch of irradiated and non-radiated (test) button mushrooms. Once directly after reception of the treated button mushrooms and once after 6 days of storage in the refrigerator. Upon inspection (non-radiated) at the outside (top side of the photos) a denser layer of vital cells was visible (colored green by FDA). After 20 seconds of UV-treatment, this dense vital layer was no longer clearly visible. After 40 seconds of UV-treatment, clearly, a top layer with dead cells could be visualized (red color).

This top layer was thicker according as the radiation with UV lasted longer. By means of image analysis, the thickness of the layer of dead cells was determined. After 40 seconds of radiation, the top layer with dead cells had, on average, a thickness of 75 μm, after 80 seconds, on average, of 130 μm and after 160 seconds, on average, of 175 μm.

After 6 days of storage, the dead top layer could still be observed.

1. A method for inhibiting or preventing spot formation at the surface of edible mushrooms, wherein the mushrooms are exposed to an effective amount of UV-light, said UV-light having an exposure energy in the range of 0.001-0.25 J/cm² based on the amount of UV-light.

2. The method according to claim 1, wherein the mushrooms are exposed to 0.01-0.15 J/cm² exposure energy, based on the amount of UV-light.

3. The method according to claim 1, wherein the mushrooms are exposed to UV-light coming from a continuous light source.

4. The method according to claim 1, wherein a substantial amount of the UV-light to which the mushrooms are exposed is UV-C light.

5. A The method according to claim 1, wherein the mushrooms are exposed to the UV-light at least prior to harvesting.

6. The method according to claim 1, wherein the mushrooms are button mushrooms.

7. The method according to claim 1, wherein the mushrooms are picked in a mechanical manner.

8. A mushroom, obtainable according to the method of claim 1.

9. A mushroom with a shelf life at 10° C. of more than 12 days.

10. The mushroom according to claim 8, wherein on at least a part of the surface a top layer is present, containing, at least substantially, dead cells, which top layer has a thickness of, on average, approximately 75-175 μm.

11. A The mushroom according to claim 8, the surface of which is essentially free of added preservatives.

12. The use of UV-light for reducing or preventing formation of brown spots at the surface of an edible mushroom.

13. The method according to claim 2, wherein the mushrooms are exposed to 0.08-0.1 J/cm² exposure energy, based on the amount of UV-light.

14. The mushroom of claim 9, having a shelf life of at least 16 days.

15. The mushroom according to claim 9, wherein on at least a part of the surface a top layer is present, containing, at least substantially, dead cells, which top layer has a thickness of, on average, approximately 75-175 μm.

16. The mushroom according to claim 9, the surface of which is essentially free of added preservatives.
